(19) United States
(12) Patent Application Publication
(10) Pub. No.: US 2025/0354797 A1
(43) Pub. Date: Nov. 20, 2025

(54) IMAGE PICK-UP DEVICE AND IMAGE PICK-UP METHOD

(71) Applicant: Panasonic Intellectual Property Management Co., Ltd., Osaka (JP)

(72) Inventors: Toshiki YAMAGUCHI, Kanagawa (JP); Kiyoshi NAKANISHI, Kanagawa (JP)

(73) Assignee: Panasonic Intellectual Property Management Co., Ltd., Osaka (JP)

(21) Appl. No.: 18/879,346

(22) PCT Filed: Apr. 13, 2023
(86) PCT No.: PCT/JP2023/015068

§ 371 Date: Dec. 27, 2024

(30) Foreign Application Priority Data
Jun. 29, 2022 (JP) 2022-104746

(51) Int. Cl. G01B 11/00; G06T 7/521

(52) U.S. Cl. CPC G01B 11/00; G06T 7/521; G06T 2207/10028

(57) ABSTRACT

This image pick-up device comprises: an image pick-up unit that radiates light on a subject which is at least partially transparent or semi-transparent, and that measures the distance to the subject by using reflected light of the light, and a light attenuating unit disposed facing the image pick-up device with the subject interposed therebetween, and that attenuates light that has passed through the subject.

### TECHNICAL FIELD

The present disclosure relates to an image pick-up device and an image pick-up method.

### BACKGROUND ART

In the related art, a technique is known that makes the estimation of the three-dimensional shape of a target object relatively less susceptible to the influence of the color of the background or the influence of the shadow of the target object in the background (see, for example, PTL 1).

In the technique disclosed in PTL 1, an image picker provided at a position where light from a light source is blocked by a target object to capture the image of the target object captures a silhouette image of the target object. Further, PTL 1 discloses that the target object may be a transparent object.

### CITATION LIST

### Patent Literature

PTL 1

Japanese Patent Application Laid-Open No. 2018-189623

### SUMMARY OF INVENTION

### Technical Problem

However, the technique disclosed in PTL 1 estimates a three-dimensional shape by detecting the contour of a target object from a silhouette image, and as such does not acquire point cloud data of a transparent object. For this reason, it is difficult for the technique disclosed in PTL 1 to reproduce the local features of a transparent object.

Non-limiting embodiments of the present disclosure contribute to the provision of an image pick-up device and an image pick-up method capable of increasing the possibility that point cloud data of a transparent object can be appropriately acquired

An image pick-up device according to an embodiment of the present disclosure including: an image picker that irradiates a subject with light and measures a distance to the subject using reflected light of the light, the subject being at least partially transparent or translucent; and a light weakener that is disposed to face the image picker with the subject interposed between the light weakener and the image picker and weakens light that has passed through the subject.

An image pick-up method according to an embodiment of the present disclosure is

a method of irradiating a subject with light and measuring a distance to the subject using reflected light of the light by an image picker, the subject being at least partially transparent or translucent, the image pick-up method including: weakening light that has passed through the subject by a light weakener that is disposed to face the image picker with the subject interposed between the light weakener and the image picker.

These comprehensive or specific aspects may be realized in a system, method, integrated circuit, computer program or recording medium, or in any combination of a system, device, method, integrated circuit, computer program and recording medium.

According to an embodiment of the present disclosure, the light that has been emitted by the image picker and has passed through the subject is weakened, and thus, the reflected light of the light that has been emitted by the image picker is relatively enhanced at the subject, thereby increasing the possibility that point cloud data of a transparent object can be appropriately acquired.

Further advantages and effects of aspects of the present disclosure are revealed in the specification and drawings. Such advantages and/or effects are provided by some embodiments and features described in the specification and drawings, but not necessarily all in order to obtain one or more identical features.

### BRIEF DESCRIPTION OF DRAWINGS

FIG. 1 is a diagram illustrating an exemplary configuration of an image pick-up system according to an embodiment;

FIG. 2 is a perspective view of the image pick-up device:

FIG. 3 is a perspective view of the image pick-up device with a box omitted;

FIG. 4 is a diagram illustrating a state where a subject is placed on a turntable;

FIG. 5 is a side view of the image pick-up device;

FIG. 6 is a top view of the image pick-up device;

FIG. 7 is a perspective view of the turntable and a rotation frame;

FIG. 8 is a diagram of the turntable and the rotation frame as viewed from above;

FIG. 9 is a diagram of the turntable and the rotation frame as viewed from a lateral side;

FIG. 10 is a partial perspective view of the rotation frame;

FIG. 11 is a cross-sectional view of the image pick-up device as viewed from a lateral side;

FIG. 12 is a cross-sectional view of the image pick-up device as viewed from above;

FIG. 13A is a diagram illustrating an exemplary configuration of an illumination member;

FIG. 13B is a diagram illustrating an exemplary configuration of a light source;

FIG. 14 is a diagram illustrating an exemplary hardware configuration of the image pick-up control device:

FIG. 15 is a diagram illustrating an exemplary block configuration of the image pick-up control device;

FIG. 16A is a diagram for describing acquisition of subject information in a case where no illumination member is provided in the image pick-up device:

FIG. 16B is a diagram for describing acquisition of subject information in a case where the illumination member is provided in the image pick-up device:

FIG. 16C is a diagram for describing acquisition of subject information in a case where the illumination member and a polarizing plate are provided in the image pick-up device:

FIG. 16D is a diagram for describing acquisition of subject information in a case where an additional illumination member is provided in the image pick-up device:

FIG. 17A is a diagram for describing acquisition of subject information in a case where no illumination member is provided in the image pick-up device through pattern matching using a random dot pattern:

FIG. 17B is a diagram for describing acquisition of subject information in a case where the illumination member is provided in the image pick-up device through pattern matching using a random dot pattern: and

FIG. 18 is a flowchart illustrating an exemplary operation of the image pick-up system.

### DESCRIPTION OF EMBODIMENTS

The following is a detailed description of the embodiment of the present disclosure, referring to the drawings as appropriate. However, more detailed explanations than necessary may be omitted. For example, detailed explanations of matters already well known or duplicate explanations for substantially identical configurations may be omitted. This is to avoid unnecessary redundancy in the following explanations and to facilitate the understanding of those skilled in the art.

The accompanying drawings and the following description are provided to enable those skilled in the art to fully understand the disclosure, and are not intended to limit the subject matter recited in the claims.

Further, the dimensions and the like of the elements illustrated in the drawings are not necessarily drawn to scale.

### Embodiments

### System Configuration Example

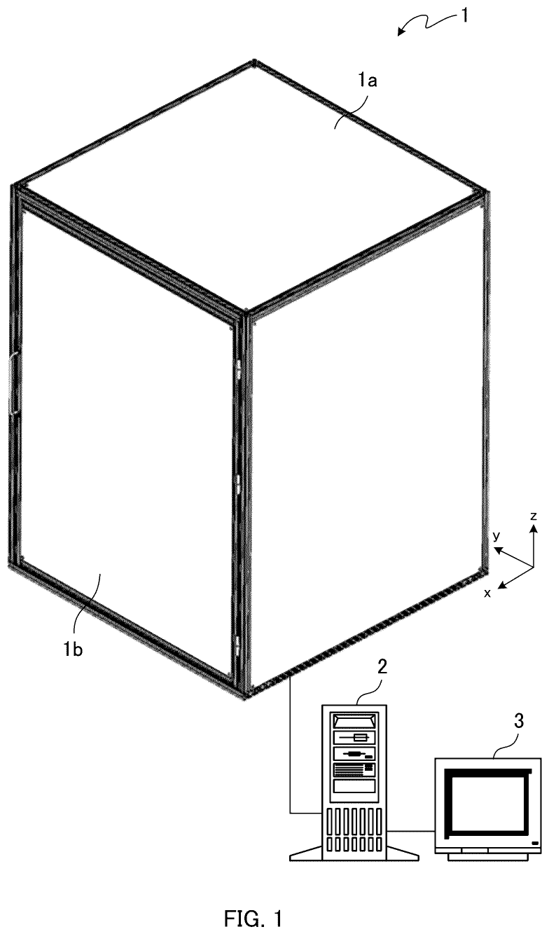

FIG. 1 is a diagram illustrating an exemplary configuration of an image pick-up system according to an embodiment. As illustrated in FIG. 1, the image pick-up system includes image pick-up device 1, image pick-up control device 2, and display (display device) 3. Hereinafter, x, y, and z axes illustrated in FIG. 1 are set for image pick-up device 1.

As illustrated in FIG. 1, image pick-up device 1 includes box 1a. Image pick-up device 1 includes, in box 1a, devices such as a sensor that acquires information such as image data and depth data (distance data) of a subject, an illumination member that assists in acquiring image data and depth data of a transparent subject, a turntable for placing the subject, and a polarizing plate that assists in acquiring image data and depth data of a transparent subject. Hereinafter, information such as image data or depth data of a subject may be referred to as subject information. Further, hereinafter, acquiring subject information of a subject may be referred to as capturing or image pick-up.

Box 1a includes door 1b. When capturing an image of a subject, the user opens door 1b and places the subject on the turntable inside box 1a. Then the user closes door 1b, and operates image pick-up control device 2 to start image pick-up of the subject.

Box 1a is composed of a material that does not allow light from the outside of box 1a to pass into the inside. That is, image pick-up device 1 captures an image of a subject without being affected by external light. Further, a plurality of movable components are present in box 1a. Box 1a ensures safety by preventing the user from touching the movable component. Note that box 1a may be omitted in a case where the room itself where image pick-up device 1 is installed is shielded from external light, or in a case where an image of a subject is captured in consideration of the influence of external light.

Image pick-up control device 2 is connected to image pick-up device 1 and display 3. Image pick-up control device 2 receives an operation from a user and controls image pick-up device 1. Further, image pick-up control device 2 displays the image of the subject on display 3 based on the subject information of the subject captured by image pick-up device 1. Image pick-up control device 2 may be composed of, for example, an information processing device such as a personal computer (PC), a tablet terminal, or a smartphone.

Image pick-up control device 2 may include display 3.

Display 3 displays an image of a subject. The image of the subject may be, for example, an image based on image data or an image based on depth data. Display 3 displays setting information for performing image pick-up. The setting information may be inputtable and settable by a user.

### Configuration Example of Image Pick-Up Device

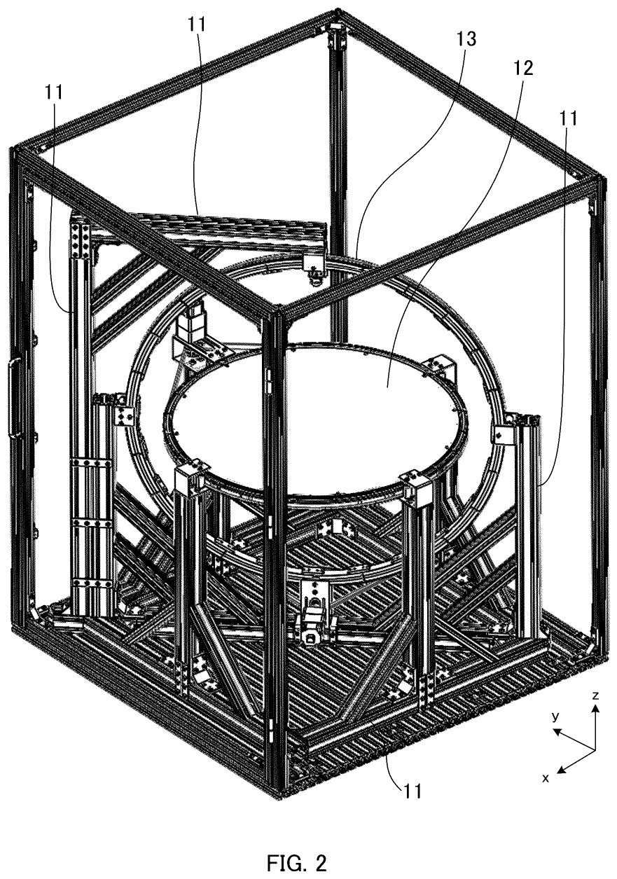

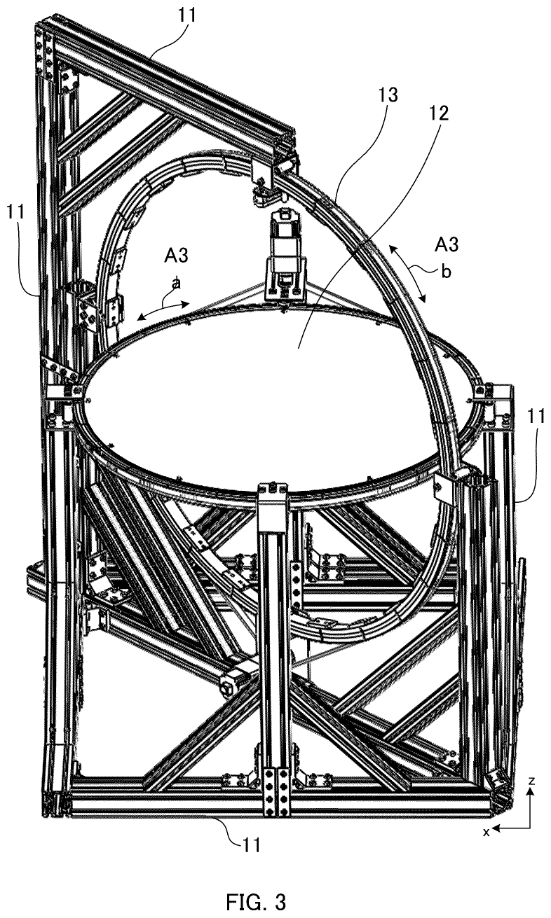

FIG. 2 is a perspective view of image pick-up device 1. FIG. 3 is a perspective view of image pick-up device 1 with box 1a omitted. As illustrated in FIGS. 2 and 3, image pick-up device 1 includes base 11, turntable 12, and rotation frame 13. Note that image pick-up device 1 also includes other components such as an illumination member (for example, illumination member 51 described later) and a polarizing plate (for example, polarizing plate 52 described later), but these other components are not illustrated in FIGS. 2 to 10 for the purpose of clearly illustrating the components other than these other components. These other components will be described with reference to FIGS. 11, 12, 13A, and 13B.

As illustrated in FIG. 2, base 11 is fixed inside box 1a. Base 11 supports turntable 12 such that turntable 12 is rotatable in directions indicated by bidirectional arrow A3a illustrated in FIG. 3. Base 11 supports rotation frame 13 in a rotatable manner in directions of bidirectional arrow A3b illustrated in FIG. 3.

Turntable 12 has a disk shape. Disc-shaped turntable 12 is supported by base 11 with its surface set to the horizontal direction, for example.

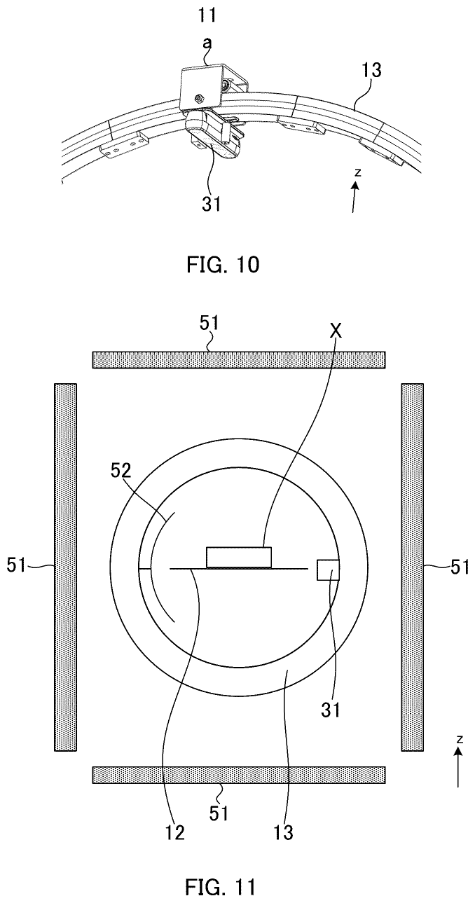

Rotation frame 13 has a ring shape. Ring-shaped rotation frame 13 is supported by base 11 such that a plane including the frame intersects the surface of turntable 12 perpendicularly. Further, ring-shaped rotation frame 13 is supported at base 11 such that turntable 12 is located (accommodated) within the ring frame. A sensor that acquires subject information of a subject on turntable 12 is attached to rotation frame 13 (see, for example, sensor 31 in FIG. 10).

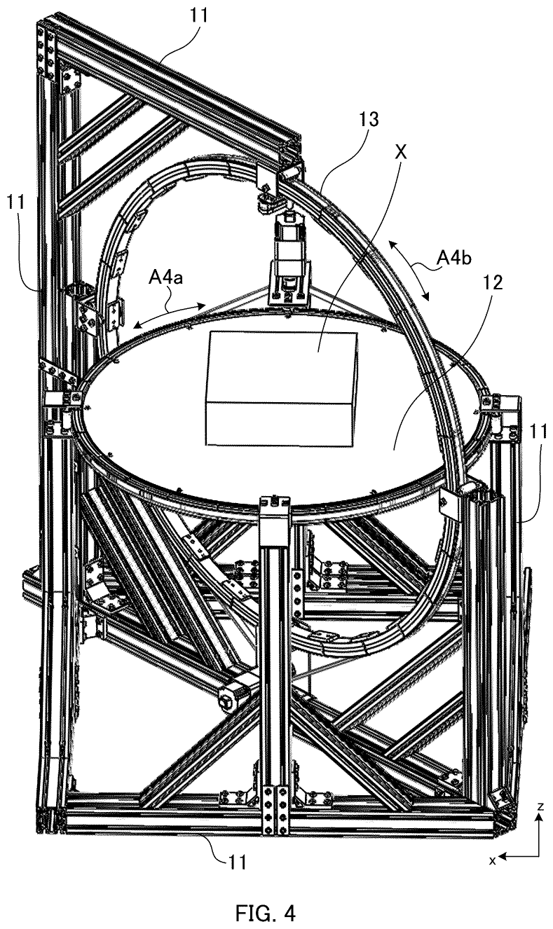

FIG. 4 is a diagram illustrating a state where subject X is placed on turntable 12. In FIG. 4, the same components as those in FIG. 3 are denoted by the same reference numerals. As illustrated in FIG. 4, subject X is placed on turntable 12. Turntable 12 is composed of a transparent member or a light (semi) transmissive member. That is, turntable 12 has light transmittance or light semi-transmittance. This is not only to reliably capture the bottom surface of subject X by the sensor, but also to handle a case where subject X is a transparent object and the subject information of the transparent object (i.e., the point cloud data of the transparent object) cannot be appropriately acquired due to the reflected light, at turntable 12, of the light emitted from the sensor. For example, in a case where the sensor emits infrared light, turntable 12 may be a red light (semi) transmissive plate.

Turntable 12 is an example of the placer according to the present disclosure.

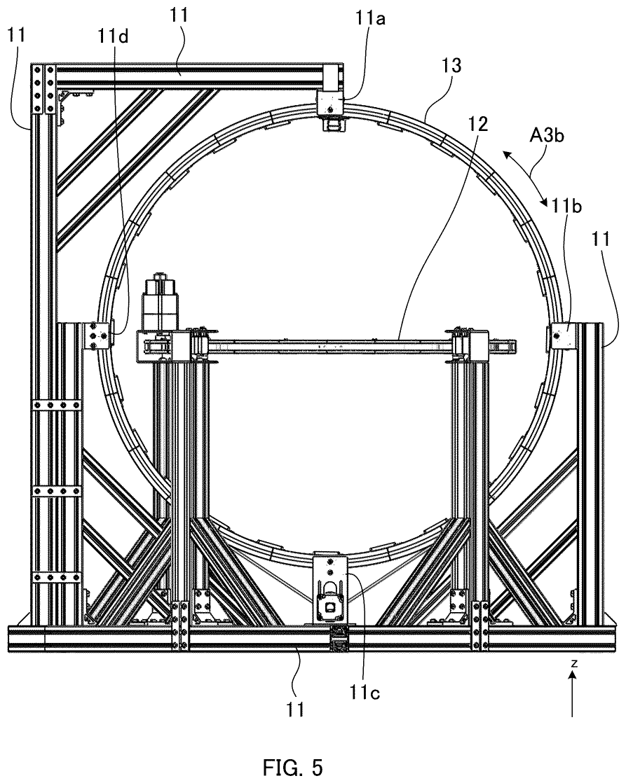

FIG. 5 is a side view of image pick-up device 1. In FIG. 5, the same components as those in FIG. 3 are denoted by the same reference numerals. As illustrated in FIG. 5, base 11 includes guides 11a to 11d. Guides 11a to 11d are fixed to base 11. Guides 11ato 11d rotatably support rotation frame 13.

Rotation frame 13 rotates in a plane that intersects the surface of turntable 12 perpendicularly. Rotation frame 13 is disposed with its rotation axis located on the plane of turntable 12. Rotation frame 13 rotates clockwise and counterclockwise in FIG. 5 as indicated by bidirectional arrow A3b in FIG. 5.

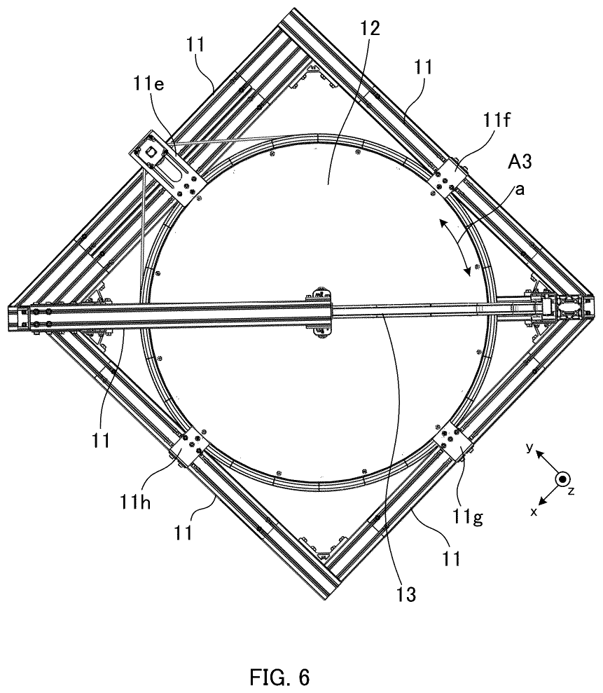

FIG. 6 is a top view of image pick-up device 1. In FIG. 6, the same components as those in FIG. 3 are denoted by the same reference numerals. As illustrated in FIG. 6, base 11 includes guides 11e to 11h. Guides 11e to 11h are fixed to base 11. Guides 11e to 11h rotatably support turntable 12 at the peripheral edge of turntable 12.

Turntable 12 rotates, for example, in a horizontal plane. Turntable 12 is disposed with its rotation axis located on the plane of rotation frame 13. Turntable 12 rotates clockwise and counterclockwise in FIG. 6 as indicated by bidirectional arrow A3a in FIG. 6.

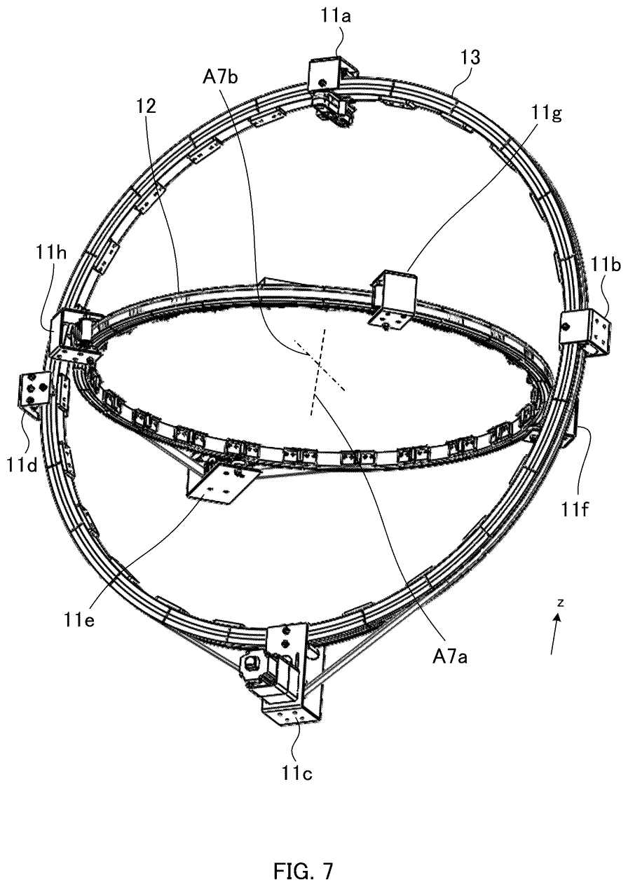

FIG. 7 is a perspective view of turntable 12 and rotation frame 13. In FIG. 7, the same components as those in FIG. 3 are denoted by the same reference numerals. Note that FIG. 7 also illustrates guides 11a to 11d that rotatably support rotation frame 13 illustrated in FIG. 5, and guides 11e to 11h that rotatably support turntable 12 illustrated in FIG. 6.

Dotted line A7a illustrated in FIG. 7 indicates the rotation axis of turntable 12. One-dot chain line A7b illustrated in FIG. 7 indicates the rotation axis of rotation frame 13. Turntable 12 and rotation frame 13 are disposed such that the rotation axis of turntable 12 and the rotation axis of rotation frame 13 are orthogonal to each other. Further, turntable 12 and rotation frame 13 are disposed such that the center of disk-shaped turntable 12 and the center of ring-shaped rotation frame 13 coincide with each other. Accordingly, turntable 12 rotates around the center of rotation frame 13, and rotation frame 13 rotates around the center of turntable 12.

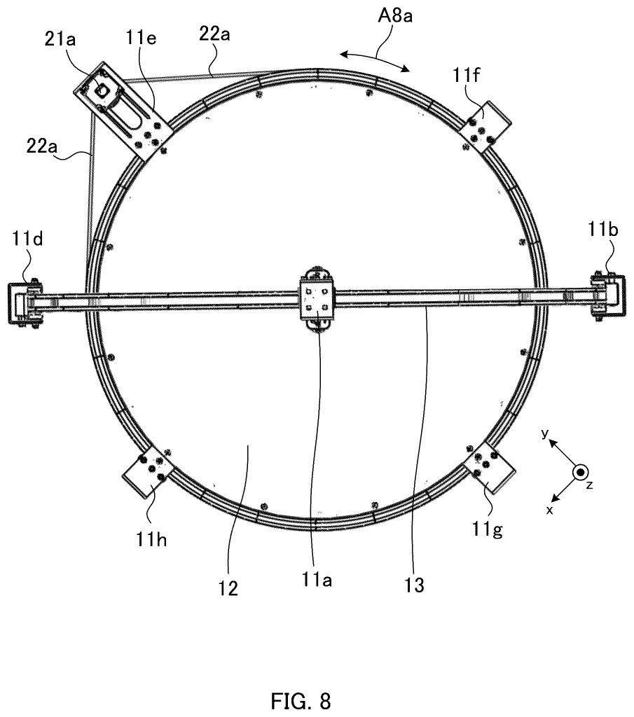

FIG. 8 is a diagram of turntable 12 and rotation frame 13 as viewed from above. In FIG. 8, the same components as those in FIG. 7 are denoted by the same reference numerals. As illustrated in FIG. 8, image pick-up device 1 includes driving device 21a and belt 22a.

Driving device 21a includes a rotation shaft. Driving device 21a is composed of, for example, a motor. Driving device 21a is fixed to, for example, guide 11e.

Belt 22a is wound around the rotation shaft of driving device 21a and the outer periphery of disk-shaped turntable 12. When the rotation shaft of driving device 21 a rotates, belt 22a rotates, and turntable 12 rotates. For example, turntable 12 rotates clockwise and counterclockwise in FIG. 8 as indicated by bidirectional arrow A8a in FIG. 8.

The rotation shaft of driving device 21a rotates in accordance with the control of image pick-up control device 2. Accordingly, turntable 12 rotates in accordance with the control of image pick-up control device 2.

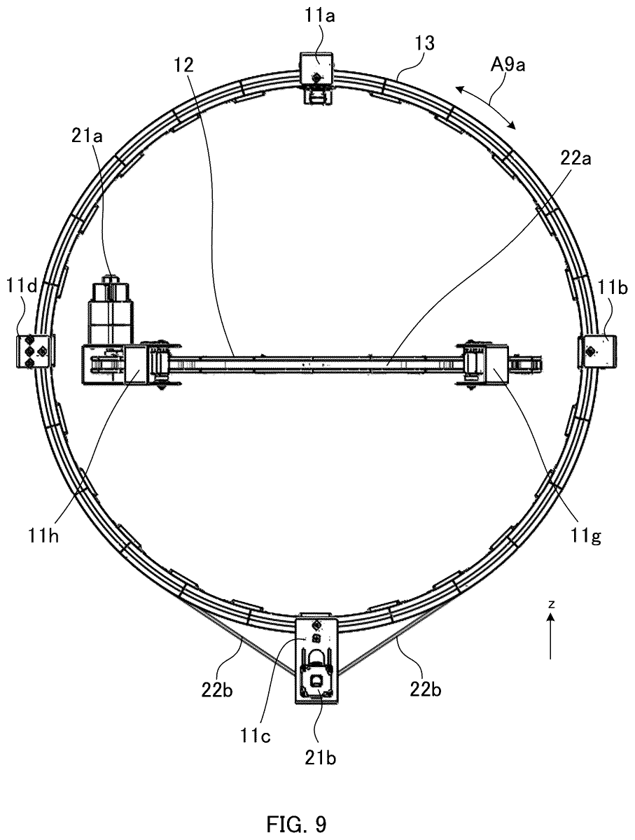

FIG. 9 is a diagram of turntable 12 and rotation frame 13 as viewed from a lateral side. In FIG. 9, the same components as those in FIGS. 7 and 8 are denoted by the same reference numerals. As illustrated in FIG. 9, image pick-up device 1 includes driving device 21b and belt 22b.

Driving device 21b includes a rotation shaft. Driving device 21b is composed of, for example, a motor. Driving device 21b is fixed to, for example, guide 11c.

Belt 22b is wound around the rotation shaft of driving device 21b and the outer periphery of ring-shaped rotation frame 13. When the rotation shaft of driving device 21b rotates, belt 22b rotates, and rotation frame 13 rotates. For example, rotation frame 13 rotates clockwise and counterclockwise in FIG. 9 as indicated by bidirectional arrow A9a in FIG. 9.

Note that the structure for rotating turntable 12 may be other than one that uses a belt. Meanwhile, when acquiring an image of the subject captured from the back side of turntable 12, it is desirable to prevent the mechanism for rotating turntable 12 from being captured in the image. Specifically, it is conceivable to use an arm or the like that grips the side surface of turntable 12 and rotates it. Further, if it is not necessary to capture the subject from the back side of turntable 12, turntable 12 may be directly rotated by a motor or the like.

The rotation shaft of driving device 21b rotates in accordance with the control of image pick-up control device 2. Accordingly, rotation frame 13 rotates in accordance with the control of image pick-up control device 2.

FIG. 10 is a partial perspective view of rotation frame 13. FIG. 10 also illustrates guide 11a illustrated in FIG. 5 in addition to rotation frame 13. As illustrated in FIG. 10, sensor 31 is fixed to the inner side of rotation frame 13. Sensor 31 also rotates along with the rotation of rotation frame 13.

Sensor 31 is connected to image pick-up control device 2. Sensor 31 acquires, for example, image data of the subject or subject information such as depth data from sensor 31 to the surface of the subject in accordance with the control of image pick-up control device 2. Sensor 31 can capture an image of a part and the entire circumference of a subject placed on turntable 12 by the rotation of turntable 12 and the rotation of rotation frame 13.

Sensor 31 may be composed of, for example, an image pick-up camera that acquires image data. Further, sensor 31 may be composed of, for example, a depth camera (three-dimensional camera) that measures the distance from sensor 31 to the subject. The depth camera may be, for example, a Time Of Flight (TOF) camera or a stereo camera. Sensor 31 transmits the acquired subject information of the subject to image pick-up control device 2.

Hereinafter, sensor 31 will be described as an example of a sensor that emits an infrared random dot pattern, and measures the distance to a subject through pattern matching by using a stereo camera. However, the present disclosure is not limited to such a sensor, and is applicable to any sensor or camera that captures images of a subject by irradiating the subject with light.

Sensor 31 is an example of the image picker according to the present disclosure.

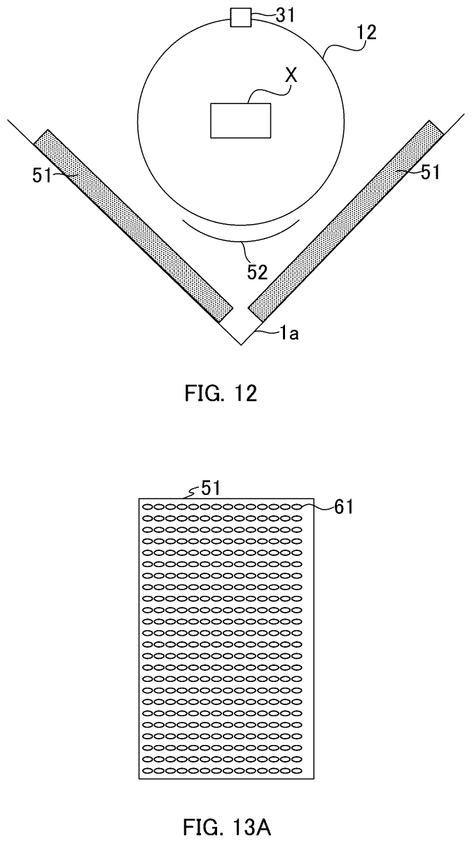

FIG. 11 is a cross-sectional view of image pick-up device 1 as viewed from a lateral side, and FIG. 12 is a cross-sectional view of image pick-up device 1 as viewed from above. In FIGS. 11 and 12, the same components as those in FIG. 4 and the like are denoted by the same reference numerals. FIGS. 11 and 12 illustrate image pick-up device 1 with a simplified shape and some components omitted. FIG. 11 illustrates turntable 12, rotation frame 13, sensor 31, illumination member 51, polarizing plate 52, and subject X, and FIG. 12 illustrates turntable 12, sensor 31, illumination member 51, polarizing plate 52, and subject X.

Illumination member 51 has a plate-like shape. Illumination member 51 is an illumination member including a plurality of light sources (for example, light source 61 described later). Illumination member 51 is fixed to all surfaces (for example, six surfaces) of the inner wall of box 1a with a rectangular parallelepiped shape, for example. Illumination member 51 may have a size that covers substantially the entire area of the corresponding surface where it is fixed, for example. Note that illumination member 51 is not limited to the above-described arrangement, and it suffices that illumination member 51 is disposed to face the side opposite to sensor 31 across subject X at least when sensor 31 captures images of subject X.

In a case where subject X is a transparent object, illumination member 51 is used to assist in acquiring subject information of a transparent object (also referred to as transparent object X). As described later, the light emitted from illumination member 51 is used for the purpose of interfering and diffusing the light that has been emitted from sensor 31 and has passed through transparent object X, and reflected light of the light (unless otherwise specified, “the light that has passed through transparent object X” is assumed to include reflected light of the light). Thus, illumination member 51 weakens the light that has passed through transparent object X. The wavelengths of these lights are likely to have a wavelength close to the wavelength of the light emitted from sensor 31, but it may possibly change to different wavelengths during the transmission through the transparent object, or the like. For this reason, the wavelength of the light emitted from the light source may preferably include light in more diverse wavelength ranges than the wavelengths of the light emitted from sensor 31. Further, in some cases illumination member 51 is used to adjust the brightness of the entire image pick-up environment by emitting visible light. Note that the visible light may contribute to the diffusion of light that has passed through transparent object X and reflected light of the light.

Illumination member 51 may emit light from all light sources or some light sources in response to the control of image pick-up control device 2 (that is, image pick-up control device 2 may adjust (determine) the light source of illumination member 51 that emits light).

Further, illumination member 51 may change the intensity of light emitted from the light source in accordance with the control of image pick-up control device 2 (that is, image pick-up control device 2 may adjust (determine) the intensity of light emitted from the light source of illumination member 51).

Further, illumination member 51 may change the wavelength of light emitted from the light source of illumination member 51 in accordance with the control of image pick-up control device 2 (that is, image pick-up control device 2 may adjust (determine) the wavelength of light emitted from the light source of illumination member 51). When capturing another object other than the transparent object (that is, the another object is an object without a transparent portion), the wavelength (color) of the light emitted from the light source of illumination member 51 can be emitted after being adjusted to match the other object (for example, based on the color of the other object), thereby making the other object stand out in the image display. Note that mixing of a transparent object and another object may be specified by control from the user or may be determined by image pick-up control device 2 itself. In a case where image pick-up control device 2 makes that determination by itself, it may determine the presence of a non-transparent object when a subject different from the background color is placed. It is difficult to determine whether a transparent object is placed, but it is understood that at least a non-transparent object is placed.

Note that illumination member 51 is not necessarily provided on all surfaces of the inner wall, and may be provided on only some of the surfaces. Further, the size of illumination member 51 may be smaller than the area of the corresponding surface where it is fixed.

Polarizing plate 52 has a spherical shape. Polarizing plate 52 may be a polarizing filter, or a colored light (semi) transmissive plate or a light (semi) transmissive filter with the same function. Polarizing plate 52 attenuates the light (of wavelength) emitted from sensor 31. Thus, polarizing plate 52 weakens the light that has passed through transparent object X. For example, polarizing plate 52 may be composed of a member that attenuates light that has passed through the subject. For example, in a case where sensor 31 emits infrared light, polarizing plate 52 may be a red light (semi) transmissive plate. Note that as long as polarizing plate 52 has a function of attenuating light of a wavelength emitted from sensor 31, polarizing plate 52 may also attenuate light of other wavelengths. For example, polarizing plate 52 may include a black plate or the like that absorbs and attenuates light of all wavelengths. Note that in the case of a black plate or the like, all light is absorbed, and thus, the black plate does not have a polarization function. However, in the present embodiment, such a configuration is also included and referred to as polarizing plate 52. However, when a configuration that attenuates light including visible light is adopted as polarizing plate 52, the light that is emitted for the purpose of adjusting the brightness of subject X is also attenuated, which affects the operation of other sensors such as an RGB camera. For example, in a case where a member that attenuates both infrared light and visible light is used as polarizing plate 52, the result of image pick-up of an RGB camera or the like is darker than when polarizing plate 52 is not present. Accordingly, in a case where a device that utilizes light of a wavelength other than the wavelength emitted by sensor 31 is used in combination, it is preferable to adopt a configuration that attenuates light of a wavelength that is not used by such a device.

Polarizing plate 52 is fixed to the inside of rotation frame 13 at a position facing the center of turntable 12 on the side opposite to sensor 31 and facing sensor 31 between illumination member 51 and subject X. Accordingly, polarizing plate 52 also rotates as rotation frame 13 rotates. Note that polarizing plate 52 is not limited to the above-described arrangement, and may be disposed to face sensor 31 with subject X interposed therebetween (between illumination member 51 and subject X) at least when sensor 31 captures images of subject X. Further, the shape of polarizing plate 52 is not limited to a spherical shape, and may be a planar shape or the like.

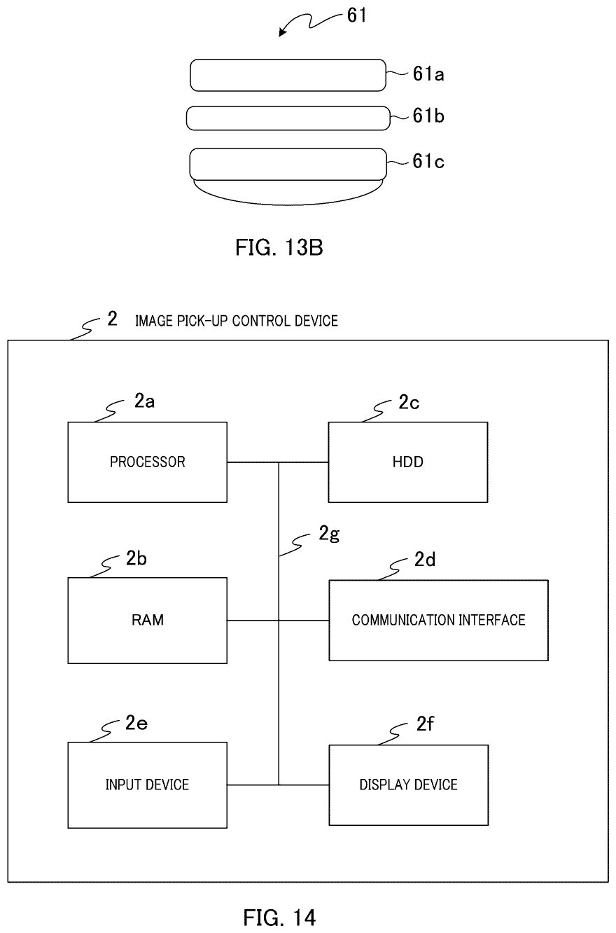

FIG. 13A is a diagram illustrating an exemplary configuration of illumination member 51. As illustrated in FIG. 13A, illumination member 51 includes a plurality of light sources 61 in a grid pattern.

FIG. 13B is a diagram illustrating an exemplary configuration of light source 61. As illustrated in FIG. 13B, light source 61 includes light emitting diode (LED) 61a, diffusion plate 61b that diffuses light emitted from LED 61a, and lens 61c. Diffusion plate 61b is disposed between LED 61a and lens 61c. Light source 61 may not include diffusion plate 61b by using a diffusion lens as lens 61c.

Illumination member 51 is an example of the illuminator, the light source, the light weakener, and the light diffuser according to the present disclosure. LED 61a is an example of the illuminator and the light source according to the present disclosure. Diffusion plate 61b or the diffusion lens is an example of the light weakener or the light interferer according to the present disclosure. Polarizing plate 52 is an example of the light weakener or the light attenuator according to the present disclosure.

### Hardware Configuration Example of Image Pick-Up Control Device

FIG. 14 is a diagram illustrating an exemplary hardware configuration of image pick-up control device 2. As illustrated in FIG. 14, image pick-up control device 2 includes processor 2a, random access memory (RAM) 2b, hard disk drive (HDD) 2c, communication interface 2d, input device 2e, display device 2f, and bus 2g.

Image pick-up control device 2 is controlled in its entirety by processor 2a. Processor 2a may be, for example, a central processing unit (CPU) or a digital signal processor (DSP). RAM 2b, HDD 2c, communication interface 2d, input device 2e, and display device 2f are connected to processor 2a via bus 2g.

RAM 2b temporarily stores an operating system (OS) and an application program to be executed by processor 2a. Further, various data necessary for processing at processor 2a are temporarily stored in RAM 2b.

HDD 2c stores the OS and application programs. Further, various data necessary for processing at processor 2a is stored in HDD 2c.

Communication interface 2d communicates with image pick-up device 1 via a wired or wireless connection.

Input device 2e receives a user operation and outputs a signal corresponding to the user operation to processor 2a. Input device 2e is, for example, a key device, a mouse, or a touch panel.

Display device 2f displays an image based on the image signal output from processor 2a. Further, display device 2f displays setting information for performing image pick-up. The setting information may be inputtable and settable by a user. Display device 2f may be display 3.

### Block Configuration Example of Image Pick-Up Control Device

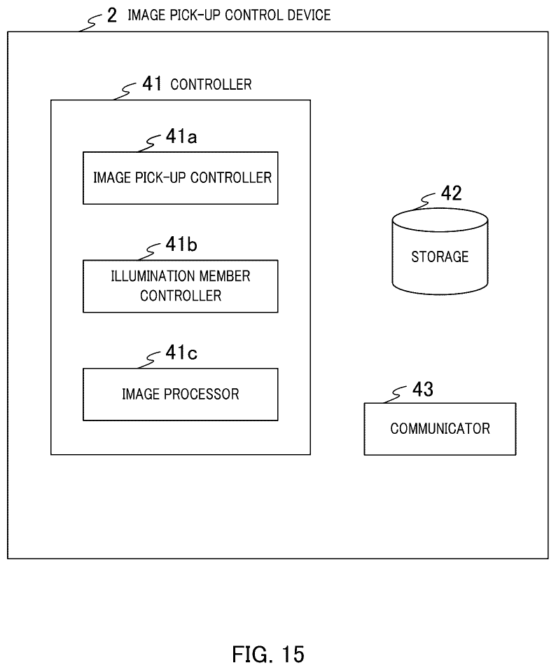

FIG. 15 is a diagram illustrating an exemplary block configuration of image pick-up control device 2. As illustrated in FIG. 15, image pick-up control device 2 includes controller 41, storage 42, and communicator 43. The functions of controller 41 are implemented by processor 2a illustrated in FIG. 14, for example. The functions of storage 42 are realized by both or one of RAM 2b and HDD 2c illustrated in FIG. 14, for example. The functions of communicator 43 are realized by communication interface 2d illustrated in FIG. 14, for example. Communicator 43 may include a transmitter and a receiver.

Controller 41 includes image pick-up controller 41a, illumination member controller 41b, and image processor 41c.

Image pick-up controller 41a controls the rotation of turntable 12 and rotation frame 13, and controls image pick-up device 1 to capture an image of a subject placed on turntable 12. For example, image pick-up controller 41a controls the rotation of turntable 12 and rotation frame 13, and controls image pick-up device 1 to capture a part or the entire circumference of the subject placed on turntable 12.

Illumination member controller 41b controls illumination member 51 in response to the operation of input device 2e by the user. For example, illumination member controller 41b controls illumination member 51 to emit light from illumination member 51 set by the user among the plurality of illumination members 51. Further, illumination member controller 41b controls illumination member 51 to emit light from a light source set by the user among the plurality of light sources of illumination members 51. Further, illumination member controller 41b controls illumination member 51 to emit light with an intensity set by the user. Further, illumination member controller 41b controls illumination member 51 to emit light of a wavelength set by the user.

Illumination member controller 41b is an example of the adjuster according to the present disclosure.

Image processor 41c executes the following processing to generate an image based on the subject information and display the image on display device 2f or display 3. Image processor 41c converts the subject information (depth data) acquired by sensor 31 from each viewpoint (angle) into point cloud data. Image processor 41c synthesizes and interpolates the point cloud data and maps it to a predefined coordinate space. Image processor 41c executes processing such as image smoothing and exclusion of outliers. Note that the user can adjust the parameters in the above-described processing as necessarily by operating input device 2e while confirming the results of the above-described processing in real time on the screen of display device 2f or display 3.

### Acquisition of Subject Information of Transparent Object

The following describes the acquisition of the subject information of subject X, which is a transparent object placed on turntable 12 in a case where illumination member 51 is not provided in image pick-up device 1, and the acquisition of the subject information of transparent object X placed on turntable 12 in the present embodiment.

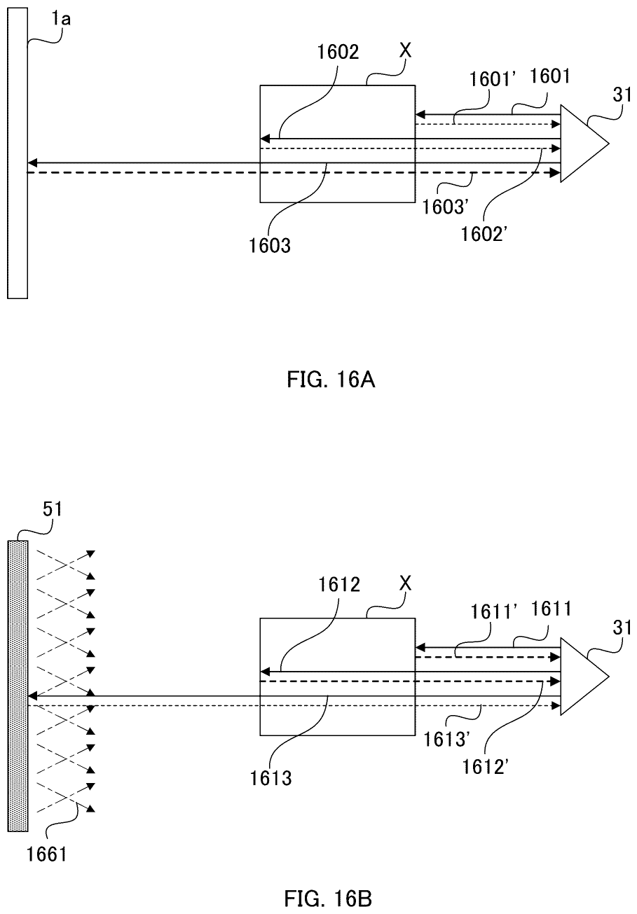

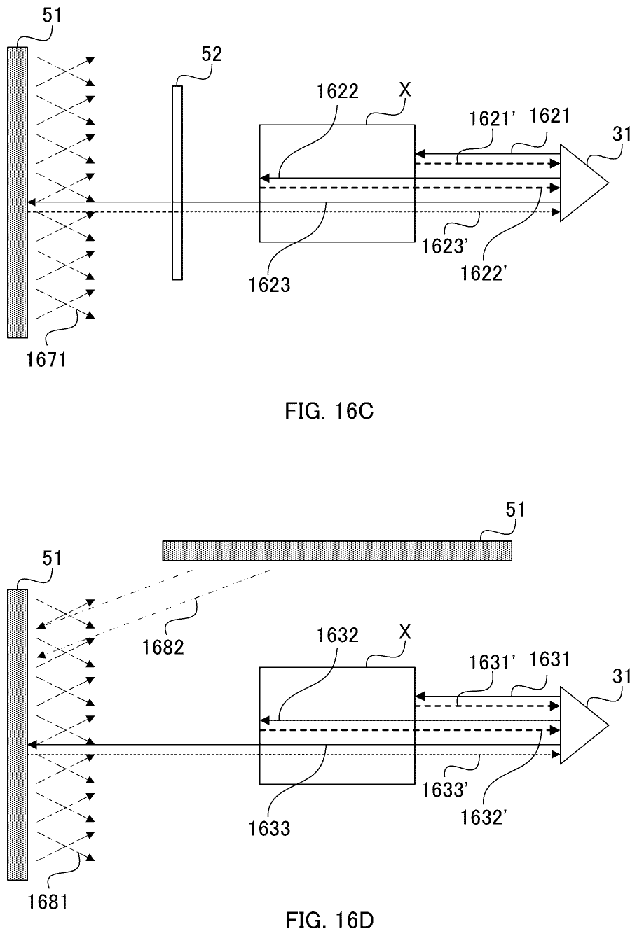

First, acquisition of subject information in a case where illumination member 51 is not provided in image pick-up device I will be described with reference to FIG. 16A. FIG. 16A is a schematic view of image pick-up device 1 as viewed from a lateral side in a case where illumination member 51 is not provided in image pick-up device 1.

Infrared light 1601 and 1602 emitted from sensor 31 is reflected on the surface of transparent object X, and infrared reflection light 1601′ and 1602′ is captured (detected) by sensor 31. Further, infrared light 1603 emitted from sensor 31 passes through (transmits) transparent object X so as to be reflected on the surface of the normal wall surface (the inner wall of box 1a), and infrared reflection light 1603′ that has passed through transparent object X again is captured by sensor 31.

In this case, the level of infrared reflection light 1603′, which is noise, is relatively larger than the level of infrared reflection light 1601′ and 1602′, making it difficult to acquire the subject information of transparent object X.

The following describes, with reference to FIG. 16B, acquisition of the subject information in a case where illumination member 51 is provided in image pick-up device 1 (the present embodiment). FIG. 16B is a schematic view of image pick-up device 1 as viewed from a lateral side in a case where illumination member 51 (illumination member 51 fixed to the side surface) is provided in image pick-up device 1.

Infrared light 1611 and 1612 emitted from sensor 31 is reflected on the surface of transparent object X, and infrared reflection light 1611′ and 1612′ is captured by sensor 31. Further, infrared light 1613 emitted from sensor 31 passes through transparent object X so as to be reflected on the surface of illumination member 51, and infrared reflection light 1613′ that has passed through transparent object X again is captured by sensor 31.

In this case, the emission and diffusion of light by illumination member 51 cause diffused light 1661 from illumination member 51 and infrared reflection light 1613′, which is noise, to interfere with each other, resulting in the weakening of infrared reflection light 1613′. Thus, infrared reflection light 1611′ and 1612′ is relatively enhanced, and the possibility that the subject information of transparent object X (i.e., the point cloud data of transparent object X) can be appropriately acquired can be increased.

The following describes, with reference to FIG. 16C, acquisition of the subject information in a case where illumination member 51 and polarizing plate 52 are provided in image pick-up device 1 (the present embodiment). FIG. 16C is a schematic view of image pick-up device 1 as viewed from a lateral side in a case where illumination member 51 (illumination member 51 fixed to the side surface) and polarizing plate 52 are provided in image pick-up device 1. Note that for the sake of clarity, polarizing plate 52 is illustrated in a planar shape rather than a spherical shape.

Infrared light 1621 and 1622 emitted from sensor 31 is reflected on the surface of transparent object X, and infrared reflection light 1621′ and 1622′ is captured by sensor 31. Further, infrared light 1623 emitted from sensor 31 passes through transparent object X and polarizing plate 52 so as to be reflected on the surface of illumination member 51, and infrared reflection light 1623′ that has passed through polarizing plate 52 and transparent object X again is captured by sensor 31.

In this case, in the same manner as described above, infrared reflection light 1623′, which is noise, is weakened by the interference between diffused light 1671 from illumination member 51 and infrared reflection light 1623′ due to the emission and diffusion of light by illumination member 51, and infrared reflection light 1623′ is further weakened due to the attenuation of light during transmission through polarizing plate 52. Thus, infrared reflection light 1621′ and 1622′ is relatively enhanced, and the possibility that the subject information of transparent object X (i.e., the point cloud data of transparent object X) can be appropriately acquired can be increased. Note that the point cloud data obtained from infrared reflection light 1621′ and 1622′ cannot distinguish between the outside and the inside of transparent object X. However, by integrating the point cloud data captured from multiple directions of transparent object X, the shape of transparent object X can be reproduced even with the unclear distinction between the outside and the inside. For this reason, in a case where it is necessary to distinguish between the outside and the inside of transparent object X, the obtained point cloud data may be analyzed after the image pick-up of transparent object X is completed. Further, analyzing the time until each infrared reflection light 1621′ and 1622′ is acquired by sensor 31 can estimate that the reflected light returning earlier is the light reflected on the surface close to sensor 31. For this reason, it is possible to distinguish between the outside and the inside of transparent object X based on this analysis result without capturing transparent object X from a plurality of directions. Note that an example case where it is necessary to distinguish between the outside and the inside of transparent object X may be a case of creating a CG of transparent object X, for example. In the creation of CG, information on the normal line of each surface may be used to reproduce the reflection of light. However, in this case, the direction of the normal line is reversed depending on whether the surface of transparent object X is facing the front or the back. Therefore, if the surface is incorrectly oriented, an accurate CG cannot be reproduced. For this reason, in such a case, it is necessary to distinguish between the outer surface and the inner surface of transparent object X.

The following describes, with reference to FIG. 16D, the acquisition of the subject information in a case where an additional illumination member 51 is provided in image pick-up device 1 (the present embodiment). FIG. 16D is a schematic view of image pick-up device 1 as viewed from a lateral side in a case where an additional illumination member 51 (illumination member 51 fixed to the upper surface) is provided in image pick-up device 1.

Infrared light 1631 and 1632 emitted from sensor 31 is reflected on the surface of transparent object X, and infrared reflection light 1631′ and 1632′ is captured by sensor 31. Further, infrared light 1633 emitted from sensor 31 passes through transparent object X so as to be reflected on the surface of illumination member 51, and infrared reflection light 1633′ that has passed through transparent object X again is captured by sensor 31.

In this case, in the same manner as described above, infrared reflection light 1633′, which is noise, is weakened by the interference between diffused light 1681 from illumination member 51 fixed to the side surface and infrared reflection light 1633′ due to the emission and diffusion of light by illumination member 51, and infrared reflection light 1633′, which is noise, is further weakened by the interference between diffused light 1682 from illumination member 51 fixed to the upper surface and infrared reflection light 1633′. Thus, infrared reflection light 1631′ and 1632′ is relatively enhanced, and the possibility that the subject information of transparent object X (i.e., the point cloud data of transparent object X) can be appropriately acquired can be increased. Note that the additional illumination member is not limited to illumination member 51 fixed to the upper surface, and may be disposed at a predetermined position (corner or near the corner) of box 1a, a predetermined position of turntable 12, a predetermined position of rotation frame 13, or the like, for example.

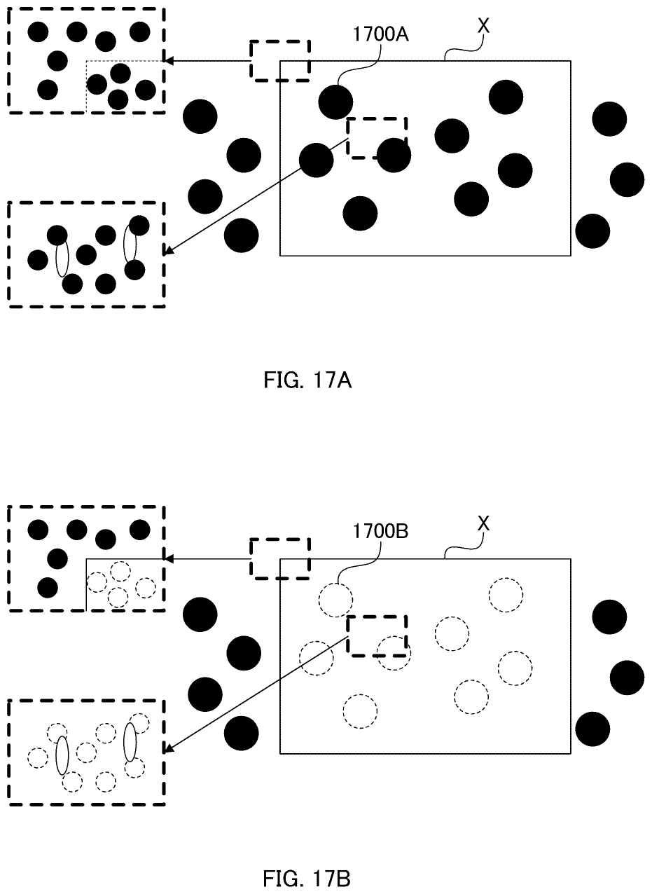

The following describes, with reference to FIG. 17A, acquisition of subject information in a case where illumination member 51 is not provided in image pick-up device 1 through pattern matching using a random dot pattern. FIG. 17A is a schematic view illustrating dot pattern 1700A as viewed from sensor 31 side in a case where illumination member 51 is not provided in image pick-up device 1.

The infrared light emitted from sensor 31 includes one that is reflected on the surface of transparent object X and is captured by sensor 31, and one that passes through transparent object X so as to be reflected on the surface of the normal wall surface (the inner wall of box 1a) and captured by sensor 31.

As described above, since the level of the latter reflected light is relatively large, dot pattern 1700A in the solid line rectangle in FIG. 17A is a pattern reflected on a normal wall surface.

Accordingly, as illustrated in the dashed line rectangle in which the left upper corner rectangular region of the solid line rectangle of transparent object X is enlarged, the boundary of transparent object X is unclear in the block used in the pattern matching.

Further, as illustrated in the dashed line rectangle in which the rectangular region in the solid line rectangle of transparent object X is enlarged, the reflected light (gloss or the like) from transparent object X indicated by the ellipse is less likely to be detected in the block used in the pattern matching.

The following describes, with reference to FIG. 17B, acquisition of subject information in a case where illumination member 51 is provided in image pick-up device 1 through pattern matching using a random dot pattern. FIG. 17B is a schematic view illustrating dot pattern 1700B as viewed from sensor 31 side in a case where illumination member 51 is provided in image pick-up device 1.

The infrared light emitted from sensor 31 includes one that is reflected on the surface of transparent object X and is captured by sensor 31, and one that passes through transparent object X so as to be reflected on the surface of illumination member 51 and captured by sensor 31.

As described above, the latter reflected light is weakened, and thus, dot pattern 1700B indicated by the broken line in the solid line rectangle in FIG. 17B is less likely to be detected.

Accordingly, as illustrated in the dashed line rectangle in which the left upper corner rectangular region of the solid line rectangle of transparent object X is enlarged, the boundary of transparent object X becomes clear in the block used in the pattern matching.

Further, as illustrated in the dashed line rectangle in which the rectangular region in the solid line rectangle of transparent object X is enlarged, the reflected light from transparent object X indicated by the ellipse is easily detected in the block used in the pattern matching.

As described above, in the present embodiment, the boundary perimeter of transparent object X is clarified, and pattern matching is enabled, thereby increasing the possibility that the subject information of transparent object X (i.e., the point cloud data of transparent object X) can be appropriately acquired and improving the accuracy of the point cloud data.

### Operation Example of Image Pick-Up System

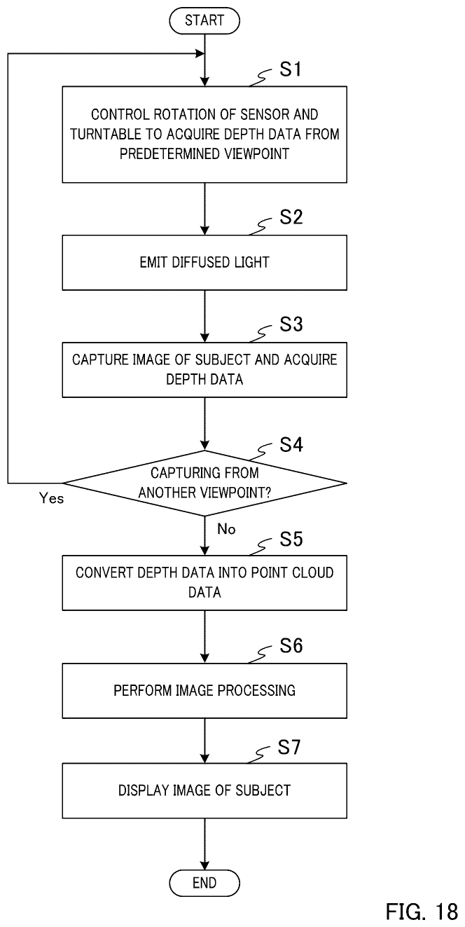

FIG. 18 is a flowchart illustrating an operation example of the image pick-up system. In a state where door 1b is closed, the image pick-up system may start the operation of the flowchart illustrated in FIG. 18 in response to a press of an image pick-up start button (not illustrated) displayed on display 3, for example. Note that it is assumed that before the start of the flowchart illustrated in FIG. 18, subject (transparent object) X is placed by a user at a predetermined position (for example, the center) of turntable 12, for example.

Image pick-up control device 2 (image pick-up controller 41a) controls the rotation of sensor 31 and turntable 12 to acquire depth data from a predetermined viewpoint (angle) (S1). For example, the viewpoint from which the image is captured may be set in advance in the image pick-up system or may be set by the user. Based on such a setting, image pick-up control device 2 (image pick-up controller 41a) may control the rotation of sensor 31 and turntable 12.

When the rotation of sensor 31 and turntable 12 stops, image pick-up control device 2 (illumination member controller 41b) controls illumination member 51 to emit diffused light (S2).

In a state where the diffused light is emitted, image pick-up control device 2 (image pick-up controller 41a) controls sensor 31 to capture an image of the subject placed on turntable 12 and acquire depth data (S3).

Image pick-up control device 2 (image pick-up controller 41a) determines whether to capture an image from another viewpoint (S4). For example, the viewpoint from which the image is captured may be set in advance in the image pick-up system or may be set by the user. Image pick-up control device 2 (image pick-up controller 41a) may determine whether to capture an image from another viewpoint based on such a setting.

In a case where the image is captured from another viewpoint (Yes in S4), the flow returns to S1.

In a case where the image is not captured from another viewpoint (No in S4), image pick-up control device 2 (image processor 41c) converts the depth data transmitted from sensor 31 into point cloud data (S5). Note that before or after S5, or in parallel with S5, image pick-up control device 2 (illumination member controller 41b) controls illumination member 51 to stop the emission of the diffused light.

Image pick-up control device 2 (image processor 41c) performs image processing using the point cloud data (S6).

Image pick-up control device 2 (image processor 41c) displays the image of the subject on display 3 based on the result of the image processing (S7). Then, the flow ends.

### Supplement to Embodiment

Image pick-up device 1 and image pick-up control device 2 described above may be regarded as a single device and may be referred to as an image pick-up device.

A plurality of the above-described sensors 31 may be provided. In a case where the plurality of sensors 31 are provided, the image pick-up time of the subject can be shortened. For example, when capturing the entire circumference of the subject, it is not necessary to rotate turntable 12 and rotation frame 13 by 360 degrees, which can shorten the image pick-up time.

In the above, image pick-up device 1 including turntable 12 and rotation frame 13 has been described as an example, but the configuration of image pick-up device 1 may be different from the above-described structure as long as image pick-up device 1 can capture an image of a subject from an arbitrary direction. For example, a placing table that does not have a rotation function may be employed as a table on which a subject is placed. In this case, it suffices to increase the movable range of the camera instead of rotating the placing table. Further, the position of a sensor (camera) or the like may be controlled using another mover, such as a robot arm, other than the rotation frame without providing rotation frame 13. A placing table that does not have a rotation function is an example of the placer according to the present disclosure. Rotation frame 13 and the robot arm are examples of the mover according to the present disclosure.

Further, in the above, a configuration of using the combination of illumination member 51 and polarizing plate 52 has been described, but it is not necessary to use the combination of illumination member 51 and polarizing plate 52 as long as the light that has passed through transparent object X can be sufficiently attenuated. For this reason, only one of illumination member 51 and polarizing plate 52 may be employed.

Further, transparent object X exemplified as the subject may be an object that is entirely transparent or an object that is partially transparent. Further, the transparent portion of transparent object X may be completely transparent or may be translucent.

Further, in the above, illumination member 51 emits diffused light, but it may be configured to emit light that is not diffused. Since illumination member 51 is configured to interfere with light that has passed through transparent object X by the light emitted from illumination member 51 so as to weaken the light that has passed through transparent object X, the emission light does not need to be diffused as long as the weakening is achieved. However, in a case where it is difficult to predict how the light that has passed through transparent object X is refracted or reflected, it is preferable to use diffused light to easily cause interference regardless of how the light is refracted or the like. Further, with diffused light, the light that is emitted from illumination member 51 and reaches sensor 31 after reflection or the like is also relatively weakened. Therefore, in a case where there is a risk that sensor 31 misrecognizes the light emitted from illumination member 51, it is preferable to use diffused light.

Further, in the above, illumination member 51 has been described as an illumination member that can be used for adjusting the brightness of the image pick-up environment, that is, an illumination member capable of irradiating visible light. However, since illumination member 51 only needs at least to be capable of diffusing the emission light of sensor 31, illumination member 51 may be configured to emit invisible light. In this case, since the light emitted by illumination member 51 does not affect the brightness of the image pick-up environment (recognizable by the naked eye), it is possible to independently adjust the brightness of the image pick-up environment with other illumination members and the degree of diffusion of the light that has passed through transparent object X with illumination member 51. Note that since the wavelength of the reflected light does not necessarily completely match the wavelength of the emission light of sensor 31, it is desirable that the diffused light emitted by illumination member 51 include light with a wavelength other than the wavelength of the emission light of sensor 31.

Further, in the above, illumination member 51 is controlled to emit the diffused light after the stop of the rotation of sensor 31 and turntable 12. However, in a case where the result of image pick-up of transparent object X from a plurality of directions is continuously acquired, illumination member 51 may be controlled to emit the diffused light while rotating sensor 31 and turntable 12. In this case, the light emission portion or the light intensity of illumination member 51 may be changed in accordance with the rotation of sensor 31 and turntable 12.

Further, the point cloud data of subject X created as described above is used for various processes using the three-dimensional dimensions of subject X. For example, it is conceivable to use the data for creating a CG reproducing the three-dimensional shape of subject X or for controlling a robot that grips or processes subject X.

### Effects of Embodiment

Image pick-up device 1 according to the embodiment of the present disclosure includes sensor 31 (image picker) that is fixed to rotation frame 13 and captures transparent object X, which is placed on turntable 12, from a certain angle (viewpoint) or a predetermined angle by irradiating transparent object X with infrared light. Further, image pick-up device 1 includes illumination member 51 and/or polarizing plate 52 (light weakener) that is disposed to face sensor 31 with transparent object X interposed therebetween to weaken light that has passed through transparent object X.

With the above-described configuration, the light that has been emitted by sensor 31 and has passed through transparent object X is weakened. Thus, the reflected light of the light emitted by sensor 31 on transparent object X is relatively enhanced, and thus, the possibility that the subject information of transparent object X (i.e., the point cloud data of transparent object X) can be appropriately acquired can be increased.

### Summary of Embodiment

An image pick-up device according to an embodiment of the present disclosure includes: an image picker that irradiates a subject with light and measures a distance to the subject using reflected light of the light, the subject being at least partially transparent or translucent: and a light weakener that is disposed to face the image picker with the subject interposed between the light weakener and the image picker and weakens light that has passed through the subject.

With the above-described configuration, the light that has been emitted by the image picker and has passed through the subject is weakened. Thus, the reflected light of the light emitted by the image picker is relatively enhanced at the subject, thereby increasing the possibility that the point cloud data of the subject can be appropriately acquired.

In the image pick-up device, the light weakener is a light attenuator including a member that attenuates the light that has passed through the subject.

With the above-described configuration, when the light emitted by the image picker passes through the light attenuator, attenuation occurs, and thus the reflected light of the light emitted by the image picker is relatively enhanced at the subject, thereby increasing the possibility that the point cloud data of the subject can be appropriately acquired.

In the image pick-up device, the light weakener is a light interferer that emits light that interferes with the light that has passed through the subject.

With the above-described configuration, the light emitted by the image picker is interfered with and weakened by the light emitted from the light interferer. Thus, the reflected light of the light emitted by the image picker is relatively enhanced at the subject, thereby increasing the possibility that the point cloud data of the subject can be appropriately acquired.

In the image pick-up device, the light interferer weakens the light emitted by the image picker by emitting diffused light that interferes with the light that has passed through the subject.

With the above-described configuration, the light emitted by the image picker and the diffused light interfere with each other, thereby weakening the light that has passed through the subject. Thus, the reflected light of the light emitted by the image picker is relatively enhanced at the subject, thereby increasing the possibility that the point cloud data of the subject can be appropriately acquired.

The image pick-up device further includes a light source that irradiates the subject with light and adjusts brightness of an image pick-up environment: and the light interferer emits light with a wavelength different from a wavelength of the light emitted by the light source.

With the above-described configuration, it is possible to increase the possibility that point cloud data of a subject can be appropriately acquired without affecting the brightness of the image pick-up environment or while reducing such an influence.

The image pick-up device further includes an adjuster that adjusts the wavelength of the light emitted by the light source based on a color of another subject in a case where the subject and the another subject that does not have a transparent or translucent portion are included in an image pick-up target.

With the above-described configuration, it is possible to make other subjects stand out in image display.

The image pick-up device further includes a placer on which the subject is placed and which has light transmittance or light semi-transmittance.

With the above-described configuration, it is possible to enhance the possibility that point cloud data of the subject can be appropriately acquired by suppressing the reflected light of the light, which is emitted by the image picker, at the subject from being relatively weakened by the reflected light of the light, which is emitted by the image picker, at the placer.

In the image pick-up device, the image picker emits an infrared dot pattern as the light emitted by the image picker, and measures the distance to the subject through pattern matching.

With the above-described configuration, it is possible to improve the accuracy of point cloud data.

An image pick-up method according to an embodiment of the present disclosure is a method of irradiating a subject with light and measuring a distance to the subject using reflected light of the light by an image picker, the subject being at least partially transparent or translucent, the image pick-up method including: weakening light that has passed through the subject by a light weakener that is disposed to face the image picker with the subject interposed between the light weakener and the image picker.

With the above-described configuration, the light that has been emitted by the image picker and has passed through the subject is weakened. Thus, the reflected light of the light emitted by the image picker is relatively enhanced at the subject, thereby increasing the possibility that the point cloud data of the subject can be appropriately acquired.

The embodiments are described above with reference to the drawings, but the present disclosure is not limited to such examples. It is clear that one skilled in the art can conceive of various examples of changes or modifications within the scope of the claims. It is understood that such changes or modifications also belong to the technical scope of the present disclosure. In addition, each component in the embodiments may be arbitrarily combined to the extent that the intent of the present disclosure is not departed from.

In the embodiment, the word “ . . . part” used for each component may be replaced by other words such as “ . . . circuit (circuitry)”, “ . . . assembly”, “ . . . device”, “ . . . unit”, and “ . . . module”.

The present disclosure may be realized in software, hardware, or software in conjunction with hardware. Each functional block used in the description of the above embodiments may be partially or entirely realized as an LSI, an integrated circuit, and each process described in the above embodiments may be partially or entirely controlled by a single LSI or a combination of LSIs. The LSI may be composed of individual chips or a single chip to include some or all of the functional blocks. The LSI may have data inputs and outputs. LSIs may be referred to as ICs, system LSIs, super LSIs, or ultra LSIs, depending on the level of integration.

The method of integrated circuitry is not limited to LSIs, but may be realized as dedicated circuits, general-purpose processors or dedicated processors. Field Programmable Gate Array (FPGA), which can be programmed after LSI manufacturing, and reconfigurable processors, which can reconfigure the connections and/or settings of circuit cells inside the LSI, may also be used. The present disclosure may be realized as digital or analog processing.

Furthermore, if another technology for integrated circuits that replaces LSI emerges due to advances in semiconductor technology or another derived technology, the integration of functional blocks may naturally be performed using that technology. The application of biotechnology, etc. may be a possibility.

This application is entitled to and claims the benefit of Japanese Patent Application No. 2022-104746 filed on Jun. 29, 2022, the disclosure each of which including the specification, drawings and abstract is incorporated herein by reference in its entirety.

### Industrial Applicability

An embodiment of the present disclosure is useful for an image pick-up device that acquires point cloud data of a transparent object.

### Reference Signs List

1 Image pick-up device
1a Box
1b Door
2 Image pick-up control device
3 Display
11 Base
11a to 11h Guide
12 Turntable
13 Rotation frame
21a, 21b Driving device
22a, 22b Belt
31 Sensor
41 Controller
41a Image pick-up controller
41b Illumination member controller
41c Image processor
42 Storage
43 Communicator
51 Illumination member
52 Polarizing plate
61: Light source
61a LED
61b Diffusion plate
61c Lens

1. An image pick-up device comprising:
an image picker that irradiates a subject with light and measures a distance to the subject using reflected light of the light, the subject being at least partially transparent or translucent; and
a light weakener that is disposed to face the image picker with the subject interposed between the light weakener and the image picker and weakens light that has passed through the subject.

2. The image pick-up device according to claim 1, wherein the light weakener is a light attenuator including a member that attenuates the light that has passed through the subject.

3. The image pick-up device according to claim 1, wherein the light weakener is a light interferer that emits light that interferes with the light that has passed through the subject.

4. The image pick-up device according to claim 3, wherein the light interferer weakens the light emitted by the image picker by emitting diffused light that interferes with the light that has passed through the subject.

5. The image pick-up device according to claim 3,
wherein the image pick-up device further includes a light source that irradiates the subject with light and adjusts brightness of an image pick-up environment; and
wherein the light interferer emits light with a wavelength different from a wavelength of the light emitted by the light source.

6. The image pick-up device according to claim 5, wherein the image pick-up device further includes an adjuster that adjusts the wavelength of the light emitted by the light source based on a color of another subject in a case where the subject and the another subject that does not have a transparent or translucent portion are included in an image pick-up target.

7. The image pick-up device according to claim 1, wherein the image pick-up device further includes a placer on which the subject is placed and which has light transmittance or light semi-transmittance.

8. The image pick-up device according to claim 1, wherein the image picker emits an infrared dot pattern as the light emitted by the image picker, and measures the distance to the subject through pattern matching.

9. An image pick-up method of irradiating a subject with light and measuring a distance to the subject using reflected light of the light by an image picker, the subject being at least partially transparent or translucent, the image pick-up method comprising:
weakening light that has passed through the subject by a light weakener that is disposed to face the image picker with the subject interposed between the light weakener and the image picker.
